(19) United States
(12) Patent Application Publication
(10) Pub. No.: US 2026/0351236 A1
(43) Pub. Date: Nov. 5, 2026

(54) RENDERING OF REVERBERATION IN CONNECTED SPACES

(71) Applicant: Telefonaktiebolaget LM Ericsson (publ), Stockholm (SE)

(72) Inventor: Werner DE BRUIJN, Stockholm (SE)

(73) Assignee: Telefonaktiebolaget LM Ericsson (publ), Stockholm (SE)

(21) Appl. No.: 19/134,146

(22) PCT Filed: Nov. 30, 2023
(86) PCT No.: PCT/EP2023/083744

§ 371 Date: May 29, 2025

Related U.S. Application Data
(60) Provisional application No. 63/429,643, filed on Dec. 2, 2022.

(51) Int. Cl. G10K 15/08

(52) U.S. Cl. CPC G10K 15/08

(57) ABSTRACT

A method (400) performed by an audio renderer (151) for rendering reverberation in a second space (302) connected to a first space (301) via a portal (300). The method includes obtaining information indicating a size of the portal. The method also includes using the information indicating the size of the portal, determining a scaling factor. The method also includes rendering a first set of one or more reverberation signals in the second space (302) using the scaling factor.

### TECHNICAL FIELD

Disclosed are embodiments related to rendering reverberation in a second space connected to a first space via a portal.

### BACKGROUND

Extended reality (XR) (e.g., a virtual reality (VR), augmented reality (AR), mixed reality (MR), etc.) systems generally include an audio renderer for rendering audio to the user of the XR system. The audio renderer typically contains a reverberation processor to generate late and/or diffuse reverberation that is rendered to the user of the XR system to provide an auditory sensation of being in the XR scene that is being rendered. The generated reverberation should provide the user with the auditory sensation of being in the acoustical environment corresponding to the XR scene (e.g., a living room, a gym, an outdoor environment, etc.).

Reverberation is one of the most significant acoustic properties of a room. Sound produced in a room will repeatedly bounce off reflective surfaces such as the floor, walls, ceiling, windows or tables while gradually losing energy. When these reflections mix with each other, the phenomena known as “reverberation” is created. Reverberation is thus a collection of many reflections of sound.

Two of the most fundamental characteristics of the reverberation in any acoustical environment, real or virtual, are: 1) the reverberation time and 2) the reverberation level, i.e., how strong or loud the reverberation is (e.g., relative to the power or direct sound level of sound sources in the space).

The reverberation time is a measure of the time required for reflected sound to “fade away” in an enclosed space after the source of the sound has stopped. It is important in defining how a room will respond to acoustic sound. Reverberation time depends on the amount of acoustic absorption in the space, being lower in spaces that have many absorbent surfaces such as curtains, padded chairs or even people, and higher in spaces containing mostly hard, reflective surfaces.

Conventionally, the reverberation time is defined as the amount of time the sound pressure level takes to decrease by 60 dB after a sound source is abruptly switched off. The shorthand for this amount of time is “RT60” (or, sometimes, T60).

Typically, for a reverberation processor used in an audio renderer, these two (and other) characteristics of generated reverberation may be controlled individually and independently. For example, it is typically possible to configure the reverberation processor to generate reverberation with a certain desired reverberation time and a certain desired reverberation level.

In an XR system, the characteristics of the generated reverberation are typically controlled by control information, e.g., special metadata contained in the XR scene description, e.g., as specified by the scene creator, which describes many aspects of the XR scene including its acoustical characteristics. The audio renderer receives this control information, e.g., from a bitstream or a file, and uses this control information to configure the reverberation processor to produce reverberation with the desired characteristics. The exact way in which the reverberation processor obtains the desired reverberation time and reverberation level in the generated reverberation may differ, depending on the type of reverberation algorithm that the reverberation processor uses to generate reverberation.

### Reverberation and Connected Spaces

As indicated above, one of the key aspects of immersive rendering of audio is the realistic rendering of reverberation associated with the virtual space of the XR scene. A special challenge is the realistic rendering of reverberation in a space (a.k.a., “acoustic environment”) (hereafter “second space”) that is connected (or “coupled”) to another space (hereafter “first space”) via one or more openings (e.g., open doors, windows) and/or one or more other interfaces between the first space and the second space (e.g., including partly transmissive walls), through which reverberation from the first space can propagate to the second space (and vice versa). In the following, the term “portal” will be used to refer to any connecting interface (e.g., opening, transmissive object, etc.) through which sound can propagate from one space to another.

In real-life, the properties of the reverberant sound fields in the connected spaces (e.g., the reverberation level, reverberation time, and other properties of the reverberant sound field in each space) are influenced by the acoustic properties of each of the connected spaces (e.g., the volume and amount of absorption in each space).

In the acoustics literature, advanced models are available for modeling the reverberant sound fields in each of two connected spaces, including the mutual influence of the acoustic properties of both spaces on the resulting reverberant sound field in each space. In principle, such models can be used to derive a complete model for the energy exchange and resulting reverberant sound fields in all connected spaces of an XR scene, but such a model quickly becomes rather complicated when more than two spaces are connected either directly, or through a “cascade” of connections.

Therefore, in practical audio rendering systems a somewhat simpler approach for simulating the effect of reverberation in connected spaces may typically be used, where part of the reverberation that is generated in one space (e.g., as a result of an active sound source that is present in that space) may be rendered into a second, connected, space as a “portal” sound source located in the opening (or, in general, interface) between the spaces, which essentially simulates the propagation of reverberation from the first to the second space through the portal. Subsequently, the sound from this portal sound source may be further “reverberated” according to the acoustic properties of the second space, in order to simulate the overall reverberation that would be perceived by a listener in that second space.

Although this simplified approach is an approximation of what happens physically and may not result in an exact match to what the more complicated physics models predict, its perceptual effect is typically very plausible, and its implementation is much easier to fit into existing rendering pipelines.

### SUMMARY

Certain challenges presently exist. For example, one problem with the portal source approach described above is that it can be challenging to determine the appropriate acoustic strength of the portal source—i.e., the acoustic strength that obtains a realistic effect (i.e., the acoustic strength resulting in a level for the reverberation propagating into the second space that is as close to the physical reality as possible). In other words, some sort of acoustic coupling factor, which controls the acoustic strength of the reverberation portal source, needs to be determined with some degree of accuracy.

Furthermore, in terms of the actual audio rendering, it needs to be determined how the determined acoustic strength of the reverberation portal source relates to the level(s) of the reverberation audio signal(s) in the first space and the audio signal(s) rendered from the reverberation portal source in the second space.

A complication is that the signal representation of the reverberation in the first space may be different from the representation of the signal rendered by the reverberation portal source into the second space. For example, the reverberation in the first space may be represented as a first set of (uncorrelated) signals that are meant to be rendered from different directions surrounding a user virtually located in the first space (i.e., an immersive rendering representation). On the other hand, the reverberation that propagates through the portal to the second space and is rendered by the reverberation portal source may be represented as a second set of signals, which may be derived from the first set of signals. For example, it may be represented by a single signal, or by a set of uncorrelated signals, depending on the specific rendering algorithm used for rendering the reverberation portal source.

In other words, from an acoustic coupling factor, a scaling factor needs to be derived that scales the reverberation portal source audio signal(s) derived from the reverberation signal(s) of the first space, such that when these scaled reverberation portal source audio signals are rendered by the reverberation portal source, the correct audio level results in the second space.

Accordingly, in one aspect there is provided a method performed by an audio renderer for rendering reverberation in a second space, Space 2, connected to a first space, Space 1, via a portal. The method includes obtaining (e.g., deriving) information indicating a size of the portal. The method also includes using the information indicating the size of the portal to determine a scaling factor. The method also includes rendering a set of one or more Space 2 reverberation signals in Space 2 using the scaling factor. The method may also include determining a reverberation strength value associated with reverberation associated with Space 1, and rendering the set of one or more Space 2 reverberation signals in Space 2 using both the reverberation strength value and the scaling factor.

In another aspect there is provided a computer program comprising instructions which when executed by processing circuitry of an audio renderer causes the audio renderer to perform the methods disclosed herein. In one embodiment, there is provided a carrier containing the computer program wherein the carrier is one of an electronic signal, an optical signal, a radio signal, and a computer readable storage medium. In another aspect there is provided a rendering apparatus that is configured to perform either of the above described methods. The rendering apparatus may include memory and processing circuitry coupled to the memory.

An advantage of the embodiments disclosed herein is that they enable an audio renderer to produce a plausible rendering of reverberation in complex XR scenes with connected acoustic spaces.

### BRIEF DESCRIPTION OF THE DRAWINGS

The accompanying drawings, which are incorporated herein and form part of the specification, illustrate various embodiments.

FIG. 1A shows a system according to some embodiments

FIG. 1B shows a system according to some embodiments.

FIG. 2 illustrates a system according to some embodiments.

FIG. 3A illustrates a portal from a first space to a second space.

FIG. 3B illustrates a portal from a first space to a second space.

FIG. 4 is a flowchart illustrating a process according to an embodiment.

FIG. 5 is a block diagram of an apparatus according to some embodiments.

### DETAILED DESCRIPTION

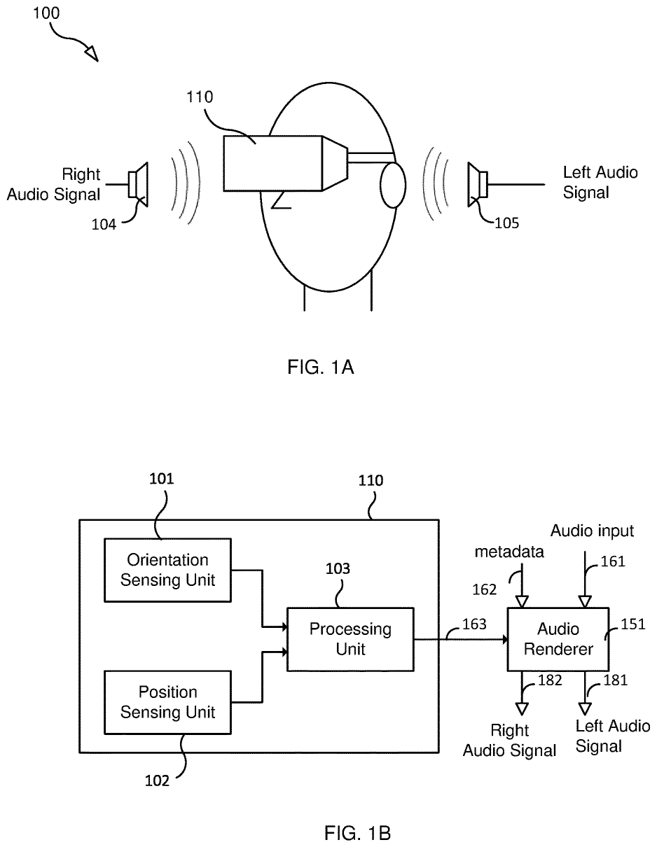

FIG. 1A illustrates an XR system 100 in which the embodiments disclosed herein may be applied. XR system 100 includes speakers 104 and 105 (which may be speakers of headphones worn by the user) and an XR device 110 that may include a display for displaying images to the user and that, in some embodiments, is configured to be worn by the listener. In the illustrated XR system 100, XR device 110 has a display and is designed to be worn on the user's head and is commonly referred to as a head-mounted display (HMD).

As shown in FIG. 1B, XR device 110 may comprise an orientation sensing unit 101, a position sensing unit 102, and a processing unit 103 coupled (directly or indirectly) to an audio render 151 for producing output audio signals (e.g., a left audio signal 181 for a left speaker and a right audio signal 182 for a right speaker as shown).

Orientation sensing unit 101 is configured to detect a change in the orientation of the listener and provides information regarding the detected change to processing unit 103. In some embodiments, processing unit 103 determines the absolute orientation (in relation to some coordinate system) given the detected change in orientation detected by orientation sensing unit 101. There could also be different systems for determination of orientation and position, e.g. a system using lighthouse trackers (LIDAR). In one embodiment, orientation sensing unit 101 may determine the absolute orientation (in relation to some coordinate system) given the detected change in orientation. In this case the processing unit 103 may simply multiplex the absolute orientation data from orientation sensing unit 101 and positional data from position sensing unit 102. In some embodiments, orientation sensing unit 101 may comprise one or more accelerometers and/or one or more gyroscopes.

Audio renderer 151 produces the audio output signals based on input audio signals 161, metadata 162 regarding the XR scene the listener is experiencing, and information 163 about the location and orientation of the listener. The metadata 162 for the XR scene may include metadata for each object and audio element included in the XR scene, as well as metadata for the XR space (“acoustic environment) in which the listener is virtually located. The metadata for an object may include information about the dimensions of the object and occlusion factors for the object (e.g., the metadata may specify a set of occlusion factors where each occlusion factor is applicable for a different frequency or frequency range). The metadata 162 may also include control parameters, such as a reverberation time value, a reverberation level value, and/or absorption parameter(s).

Audio renderer 151 may be a component of XR device 110 or it may be remote from the XR device 110 (e.g., audio renderer 151, or components thereof, may be implemented in the cloud).

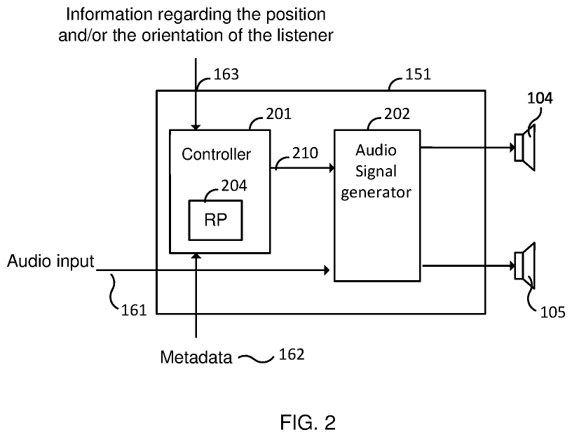

FIG. 2 shows an example implementation of audio renderer 151 for producing sound for the XR scene. Audio renderer 151 includes a controller 201 and an audio signal generator 202 for generating the output audio signal(s) (e.g., the audio signals of a multi-channel audio element) based on control information 210 from controller 201 and input audio 161. In this embodiment, controller 201 comprises a reverberation processor 204 for determining a scaling factor as described below.

In some embodiments, controller 201 may be configured to receive one or more parameters and to trigger audio signal generator 202 to perform modifications on audio signals 161 based on the received parameters (e.g., increasing or decreasing the volume level). The received parameters include information 163 regarding the position and/or orientation of the listener (e.g., direction and distance to an audio element), and metadata 162 regarding the XR scene. As noted above, metadata 162 may include metadata regarding the XR space in which the user is virtually located (e.g., dimensions of the space, information about objects in the space and information about acoustical properties of the space) as well as metadata regarding audio elements and metadata regarding an object occluding an audio element. In some embodiments, controller 201 itself produces at least a portion of the metadata 162. For instance, controller 201 may receive metadata about the XR scene and derive additional metadata (e.g., control parameters) based on the received metadata. For instance, using the metadata 162 and position/orientation information 163, controller 201 may calculate one or more gain factors (g) (e.g., the above described scaling factor or a gain derived using the scaling factor) for an audio element in the XR scene.

With respect to the generation of a reverberation signal that is used by signal generator 202 to produce the final output signals, controller 201 provides to signal generator 202 reverberation parameters, such as, for example, reverberation time and reverberation level for an acoustic environment of the XR scene, and the above described scaling factor, so that signal generator 202 is operable to generate the reverberation signal. The reverberation time for the generated reverberation is most commonly provided to the reverberation processor 204 as an RT60 value, typically for individual frequency bands, although other reverberation time measures exist and can be used as well. In typical embodiments, the metadata 162 includes all of the necessary reverberation parameters (e.g., RT60 values and reverberation level values). But in embodiments in which the metadata does not include all necessary reverberation parameters, controller 201 may be configured to generate the missing parameters.

The reverberation level may be expressed in various formats. Typically, it will be expressed as a relative level. For example, it may be expressed as an energy ratio between direct sound and reverberant sound components (DRR) or it's inverse (i.e., the RDR energy ratio) at a certain distance from a sound source that is rendered in the XR environment. Alternatively, the reverberation level may be expressed in terms of an energy ratio between reverberant sound and total emitted energy or power of a source. In the following, the term “reverberation energy ratio” is used to refer to any of these or other measures for relative reverberation level. In yet other cases, the reverberation level may be expressed directly as a level/gain for the reverberation processor.

In this context, the term “reverberant” may typically refer to only those sound field components that correspond to the diffuse part of the acoustical room impulse response of the acoustic environment, but in some embodiments it may also include sound field components corresponding to earlier parts of the room impulse response, e.g., including some late non-diffuse reflections, or even all reflected sound.

Other metadata describing reverberation-related characteristics of the acoustical environment that may be included in the metadata 162 include parameters describing acoustic properties of the materials of the environment's surfaces (describing, e.g., absorption, reflection, transmission and/or diffusion properties of the materials), or specific time points of the room impulse response associated with the acoustical environment, e.g. the time after the source emission after which the room impulse response becomes diffuse (sometimes called “pre-delay”).

All reverberation-related properties described above are typically frequency-dependent, and therefore their related metadata parameters are typically also provided and processed separately for a number of frequency bands.

### Embodiments

As noted above, this disclosure provides embodiments for producing a plausible rendering of reverberation in complex XR scenes with connected acoustic spaces. For instance, this disclosure provides means for determining an acoustic coupling factor that is indicative of the amount of reverberation that propagates from a first space (“acoustic environment”) into a second space through a portal (e.g., an opening, or a partly transmitting surface) connecting the two spaces. In one embodiment, the determined acoustic coupling factor is determined using information indicating a size of the portal.

In some embodiments, based on the acoustic coupling factor, an appropriate signal level is set for rendering one or more audio signals into the second space, where the one or more audio signals are derived from one or more reverberation signals corresponding to the first space. For example, in some embodiments, the determined acoustic coupling factor is used to derive a scaling factor, where the scaling factor is used to scale one or more audio signals derived from a set of one or more audio signals representing the reverberation in the first space. In some embodiments, the signal level for rendering one or more audio signals into the second space is further determined based on an amplitude, power, or energy of a total reverberation signal received at a position in the first space.

In some embodiments, the signal level for the signal rendered into the second space is determined based on one or more acoustic parameters for the first space, more specifically a reverberation level parameter or reverberation energy ratio parameter associated with the first space.

### Theoretical Framework

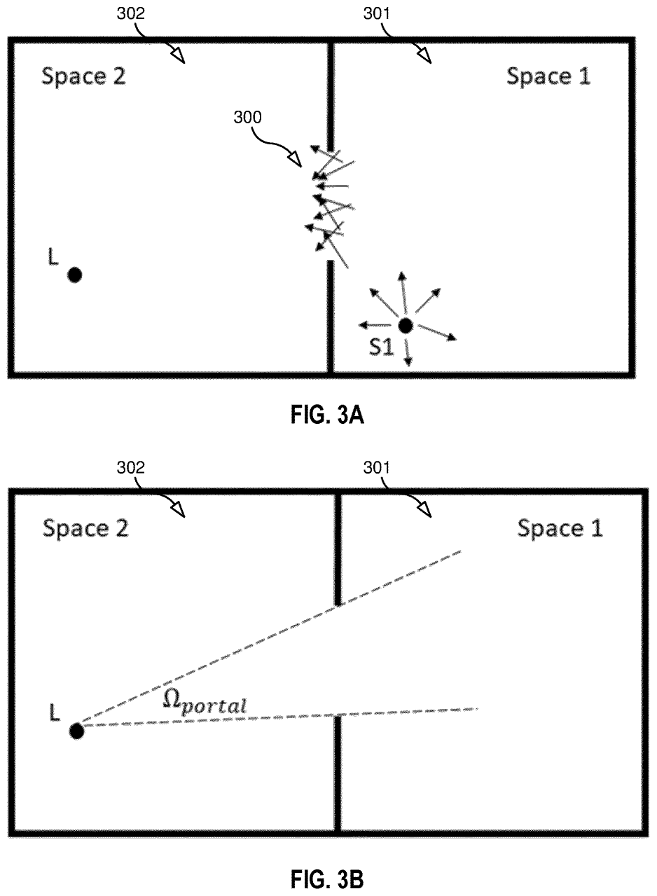

FIG. 3A shows a scene (real-life or VR) that consists of two spaces: Space 1 and Space 2. The spaces are connected to each other via a portal 300 (which may alternatively be referred to as an “opening”, “aperture”, “interface”, or similar). A sound source S1 is positioned somewhere in Space 1. Sound source S1 generates a reverberant sound field in Space 1.

The portal represents an interface between Space 1 and Space 2, through which some portion of reverberant sound energy may be exchanged between the two spaces. The portal has an “acoustic” size (a.k.a., “associated” size) (area) of Sₚₒᵣₜₐₗ m². In case the portal is an acoustically fully transparent opening, e.g., an open door or window, then the acoustic size Sₚₒᵣₜₐₗ of the portal is simply equal to the portal's geometric size (e.g., the geometrical area of the portal). More generally, if the portal is not fully open but is only partly acoustically transparent (e.g., a thin wall or thick curtain separating two spaces), the acoustic size Sₚₒᵣₜₐₗ of the portal is the equivalent size of a fully transparent opening representing the same amount of energy “leakage”. In other words, if the portal is not fully acoustically transparent, the portal's acoustic size Sₚₒᵣₜₐₗ will be smaller than its geometric size. In the following, whenever there is mention of the “size” or “area” of the portal, it is the “acoustic” size that is meant, unless explicitly stated otherwise.

Part of the reverberant sound energy that is generated by the sound source in Space 1 propagates through the portal into Space 2, where a listener L positioned in Space 2 hears the reverberation coming from Space 1 through the portal.

To determine the level of the Space 1 reverberation that is perceived by a listener L in Space 2, the amount of reverberant sound energy transferred from Space 1 to Space 2 through the portal needs to be determined.

For simplicity, Space 2 is first considered a “free field”, meaning that it is either a very large open (e.g., outdoor) space, or a space with very high acoustic absorption, such that no reverberant energy is propagated back from Space 2 into Space 1, so it is a one-way problem.

Assuming a steady-state diffuse sound field in Space 1, meaning that the amount of sound energy leaving Space 1 per unit of time through absorption and portals to connecting spaces is equal to the power of the sound source S1 in Space 1, it can be shown that the so-called average reverberant energy density in Space 1 due to the source S1 in Space 1, E_{1,1}, is equal to:

E_{1,1}=(4/c)*(P₁/A_{1,tot}), (1)

where P₁ is the acoustic power (expressed in Watts) of the sound source S1 in Space 1, A_{1,tot} is the total absorption in Space 1 including the amount of absorption represented by the portal, expressed in terms of equivalent absorptive area (m²), and c is the speed of sound in air (in m/s).

A_{1,tot} can be further specified in terms of the amount of absorption A_{1,0} in Space 1 excluding the portal, and the size of the portal Sₚₒᵣₜₐₗ (in m²), as:

A_{1,tot}=A_{1,0}+Sₚₒᵣₜₐₗ. (2)

It can further be shown that under diffuse steady state conditions, the power P_{1->2} that is transferred from Space 1 to Space 2 through the portal, expressed in Watts, is in general equal to:

P_{1->2}=(c/4)*E_{1,1}*Sₚₒᵣₜₐₗ(W). (3)

Combining equations 1, 2 and 3, we obtain for the power that is transferred from Space 1 to Space 2 through the portal:

P_{1->2=(}Sₚₒᵣₜₐₗ/A_{1,tot})*P₁=(Sₚₒᵣₜₐₗ/(A_{1,0}+Sₚₒᵣₜₐₗ))*P₁(W). (4)

The factor (Sₚₒᵣₜₐₗ/A_{1,tot}) in equation 4 is known as the “acoustic coupling factor” from Space 1 to Space 2 which indicates the fraction of the source power in Space 1 that is transferred to Space 2 under steady-state conditions.

As can be seen, the acoustic coupling factor is equal to the fraction of the total amount of absorption in Space 1 that is due to the portal. In other words, the power that is transferred from Space 1 to Space 2 is determined by the fraction of the total amount of absorption A_{1,tot} in Space 1 that is represented by the size Sₚₒᵣₜₐₗ of the portal.

If the amount of absorption A_{1,0} in Space 1 excluding the portal is very small compared to Sₚₒᵣₜₐₗ (e.g., if the walls of Space 1 are highly reflective and/or the portal is a very large opening, then the acoustic coupling factor (Sₚₒᵣₜₐₗ/A_{1,tot}) is essentially equal to 1 and the amount of power that is transferred through the portal is essentially equal to the power radiated by the source.

If, on the other hand, the amount of absorption A_{1,0} in Space 1 excluding the portal is very large compared to Sₚₒᵣₜₐₗ (e.g., if the walls of Space 1 are highly absorbing and/or the portal is very small), then the acoustic coupling factor (Sₚₒᵣₜₐₗ/A_{1,tot}) is equal to (Sₚₒᵣₜₐₗ/A_{1,0}), i.e., the ratio of the size of the portal and the amount of absorption in Space 1 excluding the portal, which will in that case be a very small number, i.e., only a very small fraction of the source power is transferred through the portal.

The average steady-state reverberant energy density E in a space is directly related to the root-mean-square steady-state reverberant acoustic pressure in the space, p, by the following relation:

p²=E*ρ₀*c², (5)

with ρ₀ the mass density of air.

So, using equation 1 one can write for the steady-state reverberant acoustic pressure in Space 1 due to source S1, p₁:

p₁²=E_{1,1}*ρ₀*c²=4*ρ₀*c*(P₁/A_{1,tot})). (6)

Combining equations 4 and 6, we find a relation between the steady-state reverberant pressure p₁ in Space 1 and the power that is transferred to Space 2:

$${P}_{1 - > 2} = ( {S}_{portal} / ( 4 * {ρ}_{0} * c ) ) * {p}_{1}^{2} . \qquad ( 7 )$$

So, equation 7 provides an expression for the amount of power that is transferred from Space 1 to Space 2 in terms of the diffuse acoustic pressure in Space 1, p₁, and the size of the portal Sₚₒᵣₜₐₗ. Importantly, equation 7 shows that if we know the diffuse acoustic pressure in Space 1 and the size of the portal, then this directly gives us the amount of power that is transferred through the portal.

Now, to arrive at an expression for the relationship between the diffuse acoustic pressure p₁ in Space 1 and the acoustic pressure p₂ in Space 2 associated with the radiation through the portal, a relationship is needed between the power P_{1->2} that is transferred through the portal, and the resulting pressure p₂ in Space 2.

If the portal is relatively small, then we can assume that the reverberant energy that is transferred through the portal is radiated equally into all directions (i.e., spherically) from the portal into Space 2. With this assumption, this results in a pressure p_{2,1 m} at 1 m distance from the portal equal to:

$${p}_{2 , 1 m}^{2} = 2 * {P}_{1 - > 2} * {ρ}_{0} * c / 4 π . \qquad ( 8 )$$

This follows from the relationship between acoustic source power P and pressure p at 1 m distance of a source radiating spherical waves:

p²=P*ρ₀*c/4π, (9)

where in equation 8 a factor of 2 has been added to the power since the power P_{1->2} is radiated only into the half-sphere on the Space 2 side of the portal (hence, the resulting pressure should be the pressure corresponding to a full-sphere radiating source of twice that power).

Combining equations 7 and 8, one finds the following relationship between the diffuse pressure p₁ in Space 1 and the rms pressure p_{2,1 m} at 1 m distance from the portal in Space 2:

$${P}_{2 , 1 m}^{2} = ( {S}_{portal} / 8 π ) * {p}_{1}^{2} . \qquad ( 10 )$$

In terms of audio signal levels in an audio rendering system, the rms acoustic pressure p is directly proportional to the rms signal level of the corresponding audio signal, so that equation 10 provides a direct way to relate the desired rms audio signal level in Space 2 to the rms reverberation audio signal level in Space 1.

So, in terms of linear acoustic pressure or linear rms audio signal level, equation 10 means that the reverberation of Space 1 should be rendered from the portal into Space 2 with a scaling such that at 1 m from the portal the resulting acoustic pressure or rms audio signal level is scaled by a factor of {square root over (Sₚₒᵣₜₐₗ/8π))} relative to the diffuse acoustic pressure or rms audio signal level of the reverberation in Space 1.

In terms of logarithmic sound pressure level or logarithmic rms audio signal level (in dB), this means that the reverberation of Space 1 is rendered in Space 2 such that the resulting level at 1 m from the portal is 10*log₁₀(Sₚₒᵣₜₐₗ/8π)=10*log₁₀(Sₚₒᵣₜₐₗ)−14 (dB) relative to the diffuse sound pressure level or rms audio signal level in Space 1.

As mentioned, this result is valid for portals that are sufficiently small, such that the assumption of spherical radiation from the portal is reasonable. It is obvious that there are limits to the applicability of equation 10, because if the size Sₚₒᵣₜₐₗ of the portal exceeds 8π m², then the rms pressure p_{2,1 m} in Space 2 would be larger than the rms pressure p₁ in Space 1, which physically can never be the case. In fact, since the acoustic power that is associated with the pressure p_{2,1 m} only corresponds to the part of the diffuse sound field in Space 1 that is incident on the opening, i.e., it corresponds to at maximum the diffuse sound power from the half-sphere on the Space 1 side of the opening,

$${P}_{2 , 1 m}^{2}$$

should never exceed

$$0.5 * {p}_{1}^{2} .$$

The reason why equation 10 can give physically implausible results for large values of Sₚₒᵣₜₐₗ is that the use of equation 9 implies that the total power that is transferred through the portal is effectively radiated from a single point, which, if this were really the case, would indeed result in a much higher pressure close to this single point than if the power would be uniformly distributed and radiated from the whole portal (as is actually the case in reality).

One way to address this issue is by modifying equation 10 as:

$${p}_{2 , 1 m}^{2} = min \{ ( {S}_{portal} / 8 π ) , 0.5 \} * {p}_{1}^{2} . \qquad ( 11 )$$

This modification prevents that the resulting level in Space 2 at 1 m from the portal can ever exceed the diffuse reverberation level in Space 1 minus 3 dB (=10 log₁₀(0.5)) as the physics require (as explained above). Note that, depending on the actual rendering method that is used for rendering the reverberation coming from the portal, an additional measure may be required at distances within 1 m from the portal to ensure that the level there also does not exceed the diffuse reverberation level minus 3 dB in Space 1. In other words, it should be ensured that the resulting level of the signal rendered from the portal does not exceed the diffuse reverberation level in Space 1 minus 3 dB anywhere in Space 2. This will also ensure a smooth transition of reverberation level when the listener moves between the spaces through the portal.

Although being a rather simple measure for solving the problem of p_{2,1 m} potentially becoming too large if Sₚₒᵣₜₐₗ exceeds 4π m² (=12.6 m²), the solution of equation 11 may actually provide a very plausible effect in many use cases.

If Sₚₒᵣₜₐₗ is substantially smaller than 4π m², then the assumption of spherical radiation from the opening is reasonable and using Sₚₒᵣₜₐₗ/8π as the scaling factor gives a plausible result.

As the size of the portal is increased and approaches 4π m², the sound pressure level at 1 m from the portal approaches the sound pressure level of the reverberation in Space 1 minus 3 dB, finally reaching and remaining at that level for portals larger than 4π m². The latter seems quite plausible, because the reverberation experienced when standing at 1 m distance from the center of an opening with a size of, for example, 4×3 m (=12 m2) is very similar to when standing in the opening itself.

From the derived rms pressure at 1 m from the portal, p_{2,1 m}, it is straightforward to derive the rms acoustic pressure p₂ at any position in Space 2 at an arbitrary distance d from the portal, from: p₂(d)=p_{2,1 m}/d. This assumes that the portal source radiates as a point source.

Alternatively, other models for modeling the radiation from the portal may be used instead of the spherical radiation model of equations 8 and 9, leading to alternative equations to equation 8 for the relationship between the transferred power P_{1->2} and the resulting pressure p₂ in Space 2, and the resulting relationship between the pressures p₁ and p₂ of equations 10 and/or 11 (and, as a result, the scaling that is eventually applied to the audio signal rendered from the portal in order to obtain the correct rendered audio signal level in Space 2).

For example, the reverberation portal source may be modeled as a spatially diffuse extended sound source, e.g., a spatially diffuse line source or planar source having a size equal to the geometrical size of the portal. Acoustic radiation models for such spatially diffuse extended sources, relating the acoustic source power to the resulting acoustic pressure at a given distance from the source, are available in the literature.

So, in some embodiments an alternative equation to equation 10 or 11 may be used of the form:

$${P}_{2 , 1 m}^{2} = C 1 * {S}_{portal} * {p}_{1}^{2} , \qquad ( 12 )$$

with C1 a constant, or even more generally:

$${P}_{2 , 1 m}^{2} = f ( {S}_{portal} ) * {p}_{1}^{2} , \qquad ( 13 )$$

where f(Sₚₒᵣₜₐₗ) is a function of the portal size Sₚₒᵣₜₐₗ.

### Alternative Theoretical Framework

An alternative but to a large extent equivalent theoretical view on the transfer of reverberation from Space 1 to Space 2 will be presented.

Because a theoretical diffuse reverberant sound field in each point in a space is made up of equally strong uncorrelated plane waves arriving from all directions, the amount of reverberant energy that propagates from Space 1 through the portal to a specific point in Space 2, can be determined by geometrical considerations.

If the average (rms) pressure of an individual reverberant plane wave arriving from a single solid angle dΩ to an arbitrary point in Space 1 is denoted as p_{d}, then the rms diffuse reverberant pressure in any point in Space 1, p₁, follows from integrating p_{d} over all solid angles dΩ:

$${p}_{1}^{2} = \int {p}_{d}^{2} d Ω = 4 π {p}_{d}^{2} . \qquad ( 14 )$$

FIG. 3B shows a point L in Space 2 and indicated is the opening angle when “looking” from point L into Space 1 through the portal. From the viewpoint of point L, the portal represents a solid angle Ωₚₒᵣₜₐₗ (with 0≤Ωₚₒᵣₜₐₗ≤2π).

Because the diffuse field in Space 1 by definition consists of equally strong uncorrelated plane waves from all direction, and because the pressure of a plane wave is constant along its path (i.e., it is independent of the distance travelled) each individual plane wave that reaches point L in Space 2 through the portal contributes the same uncorrelated pressure component p_{d}, and the resulting pressure p₂ at point L in Space 2 can therefore be determined from integrating p_{d} over the solid angle Ωₚₒᵣₜₐₗ that the portal represents at point L (where 0≤Ωₚₒᵣₜₐₗ≤2π):

$${p}_{2}^{2} = {\int }_{{Ω}_{p o r t a l}} {p}_{d}^{2} d Ω = {Ω}_{portal} {p}_{d}^{2} . \qquad ( 15 )$$

Combining equations 14 and 15, it follows that the pressure p₂ at point L in Space 2 can be determined directly from the solid angle Ωₚₒᵣₜₐₗ and the diffuse pressure in Space 1, p₁:

$${p}_{2}^{2} = ( {Ω}_{portal} / 4 π ) {p}_{1}^{2} . \qquad ( 16 )$$

In case the portal is not fully acoustically transparent but transmits a fraction T of the power that is incident on it, then p₂ is scaled accordingly.

This result can be compared to equations 10-12, and like those equations it expresses that the squared rm pressure in Space 2 is directly proportional to the squared rms pressure in Space 1, with the proportionality factor being linearly dependent on the size of the portal, where the size of the portal is expressed in terms of (equivalent) area (m²) in equations 10-12, and in terms of solid angle in equation 16.

The diffuse reverberant pressure in Space 1, p₁, may be determined from the power of the sound source and the amount of acoustic absorption in Space 1, according to equation 6.

One thing to note when comparing the two theoretical frameworks presented, is that while the first framework models the portal as a “secondary” sound source that radiates into Space 2, the second framework directly considers the reverberant energy that is received from Space 1 at a specific point in Space 2. Since the solid angle that the portal represents depends on the position relative to the portal, the pressure p₂ that results from equation 16 is dependent on the relative position of the specific position also.

Specifically, the pressure resulting from equation 16 will be very different for positions right in front of the portal, and positions to the side of (or above/below) the portal.

If the portal is sufficiently small, then the solid angle represented by a flat surface portal with a geometrical area of Sₚₒᵣₜₐₗ m² at a distance r from the observation point can be approximated by:

Ωₚₒᵣₜₐₗ≈4π*(Sₚₒᵣₜₐₗ/4πr²)*innerproduct(\vec{r},\vec{n}), (17)

with \vec{r} and \vec{n} the position vectors from the observation point to the portal and the normal vector of the portal, respectively.

At a distance of r=1 m, this becomes:

Ωₚₒᵣₜₐₗ≈Sₚₒᵣₜₐₗ*cos θ, (18)

with θ the observation angle with respect to the normal vector of the portal.

Combining equation 18 with equation 16, we see that for a position right in front of the portal, Ωₚₒᵣₜₐₗ≈Sₚₒᵣₜₐₗ, and

$${p}_{2}^{2} \approx ( {S}_{portal} / 4 π ) {p}_{1}^{2} .$$

Comparing this to equation 10, we see that the rms pressure at 1 m following from equation 16 is a factor sqrt(2) larger than the rms pressure at 1 m from equation 10. On the other hand, at a position completely to the side of the portal, Ωₚₒᵣₜₐₗ≈0, and, as a consequence, also

$${p}_{2}^{2} \approx 0 .$$

This can be interpreted as that while equation 16 represents the pressure at a specific point in Space 2, equation 10, being derived from an assumption of spherical radiation from the portal, represents the average of equation 16 at 1 m distance over all angles (i.e., the average value of the solid angle Ωₚₒᵣₜₐₗ over all angles at 1 m from the portal is equal to Sₚₒᵣₜₐₗ/2).

Also note that while in the first theoretical framework the level of the reverberation in Space 2 decreases with increasing distance from the portal in a way that is determined by the radiation model that is used for the portal source (e.g., a point source radiation model or a diffuse planar source radiation model, as discussed above), in the second theoretical framework the level decrease with increasing distance from the portal is an inherent result of the solid angle that the portal represents becoming smaller with increasing distance.

In the above, it has been assumed that Space 2 is free-field, i.e., a space that does not generate any diffuse reverberation itself space (e.g., a large outdoor space).

### Rendering

An XR audio renderer can be configured to make use of the above models to make a plausible rendering of reverberation in connected spaces of an XR environment.

In one embodiment, the rendering of reverberation that is associated with reverberation in a first Space 1, in a second, connected, Space 2, is split into two stages: (1) the rendering of the reverberation from Space 1 that directly reaches a listener in Space 2 via the portal between the two spaces and (2) the generation and rendering of reverberation that is generated in Space 2 in response to the reverberation from Space 1 that enters Space 2 through the portal (a.k.a., “second-order reverberation”).

In some embodiments only the first rendering stage may be carried out. In other embodiments only the second rendering stage may be carried out. In yet other embodiments both rendering stages may be carried out,

### The First Rendering Stage

The first rendering stage is essentially independent of the acoustics of Space 2. It is the rendering of reverberant sound that, e.g., a listener standing in a large open-air space would hear coming out of the open doors (i.e., the portal) of a cathedral in which music is being played.

In one embodiment, a method for rendering sound in Space 2 as a result of reverberant sound in a connected Space 1 may comprise the following steps:
(1: optional step) Determining a Space 1 reverberation strength value representing the strength of the reverberation in Space 1;
(2) Deriving, from one or more reverberation signals representing reverberation in Space 1 (a.k.a., “Space 1 reverberation signals”), one or more Space 2 reverberation signals for rendering in Space 2 (e.g., a downmix signal);
(3) Obtaining (e.g., determining, deriving, receiving) a size of a portal through which sound is transmitted between Space 1 and Space 2;
(4) Determining a scaling factor that models the transmission of reverberant sound from Space 1 to Space 2 using the portal size; and
(5) Rendering one or more reverberation signals in Space 2, using the Space 2 reverberation signals and the scaling factor (and, optionally, the Space 1 reverberation strength value).

In one embodiment, the method may comprise the additional step of, prior to deriving the Space 2 reverberation signals from the Space 1 reverberation signals, generating the Space 1 reverberation signals using Space 1 reverberation control information. In one embodiment, the Space 1 reverberation control information comprises a Space 1 reverberation level parameter or reverberation energy ratio parameter.

With respect to the first (optional) step, the Space 1 reverberation strength value may be determined in various ways.

In a simple scenario in which the reverberation in Space 1 is rendered from a single (i.e., non-directional, monophonic) audio signal, the Space 1 reverberation strength value may simply be determined as the rms amplitude or rms power of that signal, or in case the reverberation is rendered on the basis of a room impulse response, as the total amount of reverberant energy contained in the room impulse response.

In case the reverberation in Space 1 is rendered using multiple audio signals, e.g., as multiple uncorrelated signals rendered from a number of directions around the user, then the Space 1 reverberation strength value may be determined as the rms amplitude or power of the resulting, combined signal. As an example, suppose that the reverberation in Space 1 is rendered to a listener in Space 1 as N uncorrelated reverberation signals from N corresponding directions, each having an rms amplitude of 1/N (or rms power of 1/N²), then the resulting, combined reverberation signal has an rms power of 1/N and an rms amplitude of 1/sqrt(N).

In some cases, the Space 1 reverberation strength value does not have to be determined from actual Space 1 reverberation audio signals but can be derived more efficiently from reverberation strength metadata for Space 1. For example, the scene description metadata for the XR scene may contain a reverberation level parameter or a reverberation energy ratio parameter for Space 1 that describes the desired reverberation level in Space 1, either absolute or relative to the direct sound level or emitted source energy/power of a source in Space 1 that generates the reverberation. In such a case, the (relative) reverberation level in Space 1 is known a-priori (and it is the renderer's job to generate the Space 1 reverberation audio signals such that they result in the specified reverberation level in Space 1). For example, suppose that Space 1 has associated metadata that includes a value for the reverberant-to-direct energy ratio (RDR) in Space 1, which specifies the desired ratio of the energy of the reverberation and the energy of the direct sound at 1 m distance from an omnidirectional audio source positioned somewhere in Space 1. Now, if an omnidirectional audio source in Space 1 has an associated audio signal with a linear rms signal amplitude s, and an associated linear source gain (“volume control”) g, then the rendered linear rms signal amplitude of the direct sound at 1 m from the audio source is given by g*s, so that the rms power/energy of the direct sound signal is (proportional to) (g*s)². From this it follows that the rms energy/power of the reverberation associated with the audio source should be equal to RDR*(g*s)², so that the linear rms signal amplitude of the reverberation is sqrt (RDR)*g*s. So, the Space 1 reverberation strength value may be derived directly from the provided reverberation energy ratio (RDR) parameter for Space 1 and the source gain and audio signal level of the audio source.

In some embodiments, the Space 1 reverberation strength value is simply equal to the value of the Space 1 reverberation level parameter or reverberation energy ratio parameter obtained from the Space 1 metadata.

If the source is not omnidirectional but has an arbitrary directivity pattern associated with it which results in the source radiating a fraction X of the power of an omnidirectional source (for the same source signal), then this results in the power of the resulting reverberation also being a fraction X of that for an omnidirectional source. So, the derived Space 1 reverberation strength value may be scaled accordingly, i.e., by a factor sqrt(X) if expressed in terms of linear rms signal amplitude, or by a factor X if expressed in terms of rms signal energy/power.

Other source rendering aspects that, in addition to the source gain g, signal level s and directivity pattern discussed above, affect the gain of either the rendered direct sound level or the rendered reverberation level, may be taken into account in the calculation of the Space 1 reverberation strength value in a similar way.

In many embodiments, however, the Space 1 reverberation strength value is not explicitly needed and does not have to be applied explicitly. This is the case, e.g., when the Space 2 reverberation signals are derived directly from Space 1 reverberation signals having the correct level for rendering in Space 1. In such a case, the Space 2 reverberation signals derived from the Space 1 reverberation signals have already been implicitly scaled with the Space 1 reverberation strength. Specifically, if the Space 1 reverberation signals were generated using a provided Space 1 reverberation level parameter or reverberation energy ratio parameter, then this reverberation strength information is inherently present in the generated Space 1 reverberation signals, and, as a result, carries over automatically to the Space 2 reverberation signals derived therefrom. So, in such cases, the optional step (1) of the method described above may be omitted, and the rendering step (5) may omit using the reverberation strength value.

With respect to step 2, the step of deriving the one or more Space 2 reverberation signals for rendering in Space 2 may be done in various ways. In one embodiment, a Space 2 reverberation signal may be a monophonic or stereo downmix from the Space 1 reverberation audio signals.

In another embodiment, the one or more Space 2 reverberation signals may be derived directly from a source signal and Space 1 reverberation metadata parameters, e.g., reverberation time RT60 and reverberation energy ratio parameters, i.e., without the intermediate step of first generating actual Space 1 reverberation signals. This may be more efficient, since the Space 1 reverberation signals are not actually rendered to the listener (being located in Space 2) and are only generated as an intermediate step in generating the one or more Space 2 reverberation signals.

With respect to step 3, the size of the portal may be obtained in various ways. In some embodiments, a size of the portal may be directly available in scene description data that may explicitly specify the position and/or size of portals in a space and to which other space it connects. In other embodiments, the size may be derived from such scene description data, e.g., from geometry information. In yet other embodiments, the size of the portal may be detected heuristically, e.g., using some form of ray-tracing algorithm.

In some embodiments, the size of the portal represents the area of the portal in m². In some embodiments, the area is an equivalent area of an acoustically fully transparent opening having the same amount of “acoustic power leakage” as the portal.

In other embodiments, the size of the portal represents the solid angle corresponding to the portal with respect to a specific position in Space 2. Methods for deriving the solid angle are readily available in literature.

The scaling factor derived in step 4 represents the desired relationship between the strength (e.g., rms diffuse pressure, rms signal amplitude or rms signal power) of the reverberation in Space 1, and the strength (e.g., rms diffuse pressure, rms signal amplitude or rms signal power) of the rendered Space 2 reverberation in Space 2.

In many embodiments, the basis for deriving the scaling factor may be given by any one of the equations 10-13 or 16, from which it may be derived as the factor that relates p₁ to p₂, or, alternatively, p₁² to p₂².

So, for example, the scaling factor may be derived from equation 10 as being equal to (Sₚₒᵣₜₐₗ/8π) (or its square root), while from equation 16 it may be derived as (Ωₚₒᵣₜₐₗ/4π) (or its square root).

Finally, the derived one or more Space 2 reverberation signals are rendered to a listener in Space 2, using the scaling factor, and, optionally, the Space 1 reverberation strength value.

The scaling factor and optional Space 1 reverberation strength value may be combined to, together, determine the desired strength of the rendered Space 2 reverberation, e.g., through a relationship such as: desired strength of rendered Space 2 reverberation=scaling factor×Space 1 reverberation strength value.

Having determined the desired strength for the rendered Space 2 reverberation, an appropriate scaling gain can be determined for the Space 2 reverberation signal(s) that achieves this desired strength of the rendered Space 2 reverberation.

In some embodiments, the scaling gain for the Space 2 reverberation signal(s) comprises the scaling factor.

In some embodiments, the scaling gain for the Space 2 reverberation signal(s) is simply equal to the scaling factor.

In some embodiments, the scaling gain for the Space 2 reverberation signals may, in addition to the scaling factor, account for gain effects that are due to the specific way in which the Space 2 reverberation signal(s) are derived from the Space 1 reverberation signals, as well as for gain effects that arise due to different signal representations and rendering methods used for the Space 1 and Space 2 reverberation signals, respectively.

As already explained, the Space 1 reverberation may be represented by (and rendered to a listener virtually located in Space 1 as) a combination of multiple signals from which the Space 2 reverberation signals are derived using some signal transformation (e.g., downmix) process, which may introduce some transformation gain effect, i.e., a difference in the total signal strength before and after the transformation. The scaling gain for the Space 2 reverberation signal(s) may compensate for this transformation gain effect.

The scaling gain for the Space 2 reverberation signals may also compensate for gain effects that result from the specific ways in which the reverberation signals are combined in the specific Space 1 and Space 2 rendering methods used.

As a simple example, refer to the earlier example where the Space 1 reverberation is represented by N uncorrelated signals that are rendered from different directions around a listener in Space 1, with each signal having an rms amplitude of 1/N. The Space 1 reverberation strength value in this case is the rms amplitude of the sum of the N uncorrelated signals, which is equal to 1/sqrt(N). Suppose now that the Space 2 reverberation is derived from the Space 1 reverberation signals by simply selecting one of the N signals, which has an rms amplitude of 1/N. If this Space 2 reverberation signal is now rendered as a point source located at some position within the portal and a scaling factor according to equation 10 of (Sₚₒᵣₜₐₗ/8π), then an extra gain of sqrt(N) has to be applied to the Space 2 reverberation signal in order to obtain the correct balance between the strengths of the reverberation in Space 1 and Space 2.

So, the basic idea is that the Space 2 reverberation signals are scaled such that the resulting strength of the rendered Space 2 reverberation has the desired relationship to the strength of the Space 1 reverberation as expressed by the scaling factor.

As discussed earlier, different rendering methods may be used for rendering the derived Space 2 reverberation signals.

In one embodiment, the sound that is transmitted through the portal is rendered to the listener as a sound source positioned within the portal, i.e., a portal sound source. In one embodiment, the portal sound source is an extended sound source having a size that essentially corresponds to the geometric size of the portal. The extended sound source may be a uniform extended sound source (radiating the same signal from every point within the extent), a diffuse extended sound source (radiating spatially diffuse signals from many points within the extent), or a heterogeneous extended sound source (radiating diffuse or (partially) correlated signals from different points within the extent).

In another embodiment, the portal sound source is a point source. In one embodiment, the point source is positioned at a fixed position, e.g., a central position within the portal. In another embodiment, the point source may be dynamically positioned within the portal, depending on the listener position. For example, the point source may be positioned at the point within the portal that is closest to the listener position.

### The Second Rendering Stage

In the second rendering stage, so-called “second order” reverberation is generated in Space 2 in response to the Space 1 reverberation that enters Space 2 through the portal, according to the acoustic properties of Space 2 (e.g., Space 2 reverberation time, absorption, and/or reverberation level or reverberation energy ratio). Here, the rendering may be based on the amount of diffuse power that is transferred from Space 1 to Space 2, e.g., according to equation 7. The second-order reverberation may then be generated as the reverberation of a (notional) point source positioned in Space 2 having a source power equal to the transferred power.

More specifically, a method for implementing the second rendering stage may comprise the following steps:
(1: optional step) Determining, a Space 1 reverberation strength value representing the strength of the reverberation in Space 1;
(2) Deriving, from one or more Space 1 reverberation signals representing reverberation in Space 1, one or more reverberation input signals for generating reverberation in Space 2;
(3) Obtaining (e.g., determining, deriving, receiving) a size of a portal through which sound is transmitted between Space 1 and Space 2;
(4) Determining a scaling factor that models the transmission of reverberant sound from Space 1 to Space 2 using the portal size; and
(5) Rendering one or more Space 2 reverberation signals using the one or more reverberation input signals, the scaling factor, and, optionally, the Space 1 reverberation strength value (e.g., generating the one or more Space 2 reverberation signals using the one or more reverberation input signals, the scaling factor, and, optionally, the Space 1 reverberation strength value and producing output audio signals using the Space 2 reverberation signal(s)).

So, the steps for the second rendering stage are largely similar as for the first rendering stage, but some of the details are different, as will be explained below.

Steps 1 and 3 are the same as for the first rendering stage. So, if both the first and second rendering stage are carried out, steps 1 and 3 only have to be carried out once. Also, as was the case for the first rendering stage, step 1 may in many embodiments not be explicitly needed and can in such cases be omitted. Again, this may for example be the case when the reverberation input signal that is derived in step 2, is derived from Space 1 reverberation signals having the correct level for rendering in Space 1.

In step 2, a reverberation input signal is derived that is used as input signal to a reverberator (e.g., a reverberation processor, engine, or processing block) for generating reverberation in Space 2. Typically, only a single reverberation input signal may be required for generating the reverberation. So, if the first rendering stage is also carried out and step 2 in the first rendering stage produces a single (e.g., mono downmix) signal, then that can also be used as reverberation input signal for the second rendering stage. In principle, any signal having the general characteristics of the reverberation in Space 1 may be used as reverberation input signal in the second rendering stage, e.g., a single one out of multiple Space 1 reverberation signals, or a single reverberation signal from which the multiple Space 1 reverberation signals are generated.

In one embodiment, the method may comprise the additional step of, prior to deriving the one or more reverberation input signals for generating reverberation in Space 2 from the Space 1 reverberation signals, generating the Space 1 reverberation signals using Space 1 reverberation control information. In one embodiment, the Space 1 reverberation control information comprises a Space 1 reverberation level parameter or reverberation energy ratio parameter.

In step 4, the scaling factor may be equal to (Sₚₒᵣₜₐₗ/16π). This follows from combining equation (7) for the diffuse power P that is transferred to Space 2 with equation (9) for the pressure at 1 m distance of an omnidirectional source with source power P. It can be seen that this scaling factor is a factor of 2 smaller than the scaling factor in the first rendering stage when using the model of equation 10. The reason for this is that in the second rendering stage, the reasoning that led to the addition of the factor of 2 in equation 8 does not apply here, and it is the “normal” relationship between source power and pressure of an omnidirectional point source of equation 9 that should be used.

Finally, in step 5, Space 2 reverberation is generated and rendered in accordance with the reverberation characteristics (e.g., reverberation time, reverberation energy ratio) corresponding to Space 2, using a scaled version of the derived reverberation input signal(s) as source signal. The scaling factor and, optionally, Space 1 reverberation strength value are used to scale the gain of the reverberation input signal that is used to generate the Space 2 reverberation signal(s). The scaling may be such that when the scaled reverberation input signal would be rendered as a point source, it would have the desired level at 1 m distance from the point source, i.e., p_{2,1 m}²=scaling factor×p₁². Reverberation is now generated from the scaled reverberation input signal with a reverberator configured according to Space 2 reverberation control information (e.g., RT60 and reverberation energy ratio parameters), resulting in reverberation with the desired strength.

### Further Rendering Aspects

If, like in a typical implementation, the reverberation from Space 1 is rendered from the portal into Space 2 as an extended sound source (also known as a “volumetric” or “sized” sound source) located at and having the same geometrical size as the portal, then the result using the equation 11 will be even more realistic than if the sound from the portal is rendered as a point source located at a fixed point within the portal. In such an implementation using an extended portal sound source, as used for example in the MPEG-I Immersive Audio standard, the distance to the extended sound source, i.e., the portal, is typically not measured relative to some reference point (e.g., center point) in the portal, but relative to the closest point of it. This means that if a user would (virtually) walk along a path parallel to a large portal, the distance to the portal, i.e., the distance that is used in rendering the extended sound source to the user, remains constant, meaning that the sound level experience by the user also remains constant along this path, just as would be expected. (In contrast, if the sound coming from the portal would be rendered as a point source at a fixed position within the portal, the distance, and thus the rendered sound level, would change as the user moves along the portal).

A similar effect can be achieved if the sound from the portal is rendered to the user in Space 2 as a point source positioned at a dynamic position within the portal that moves along with the user, instead of being at a fixed position within the portal. In this case, the portal point source is dynamically positioned at the position within the portal that is closest to the user.

Furthermore, in implementations using an extended sound source for rendering the sound from the portal as described above, a distance attenuation function may typically be applied to the sound rendered from the extended portal sound source that takes into account the geometrical size of the extended sound source as viewed from the listening position, which may make the perceived effect even more realistic. For example, if the listening position is initially in front of and relatively close to the portal, the extended portal source may behave as a diffuse planar sound source and its rendered sound level may decrease only relatively slowly if the distance from the portal is increased along a trajectory perpendicular to the portal. As the distance is increased further, the level decrease rate with increasing distance becomes more rapid, eventually approaching the decrease rate of a point source.

On the other hand, if the listening position is initially at a side of the portal, the “perceived” geometric size of the extent of the volumetric source, i.e., its geometrical size as “viewed” from the listener position, is much smaller than when standing right in front of it. If the distance is now increased (while keeping the angle to the portal the same), then the rendered sound level decreases more rapidly with increasing distance than was the case for the listening trajectory in front of the portal.

### Cascading Connected Spaces

In case more than two spaces are connected to each other, the propagation of reverberation from one space to all the other spaces through the respective portals can be modeled by repeated application of equation 7 and/or equation 4 that models the amount of reverberant power transferred through a portal from one space to the next. For example, if three Spaces 1, 2 and 3 are connected via a first portal between Space 1 and Space 2, and a second portal between Space 2 and Space 3, then the amount of reverberation power transferred to Space 3 due to a sound source in Space 1 may be determined from first applying equation 7 to determine the power transferred to Space 2 via the first portal from the diffuse reverberant pressure in Space 1. Using this determined transferred power level, reverberation can be generated in Space 2 in accordance with the Space 2 acoustic parameters (e.g., RT60 and reverberation energy ratio), providing the diffuse reverberant pressure in Space 2. Then, applying equation 7 to this Space 2 diffuse reverberant pressure, the amount of power transferred to Space 1 via the second portal may be calculated.

Alternatively to the step of rendering the reverberation in Space 2 based on the determined amount of power from Space 1 to Space 2 and determining the diffuse reverberant pressure in Space 2 from that, the amount of power transferred to Space 3 may also be determined directly by applying equation 4 to the result of the first step, i.e., with the amount of power transferred from Space 1 to Space 2 obtained in the first step as P1 in equation 4. The only issue here is that applying equation 4 requires the amount of absorption in Space 2, A_{1,tot} (or A_{1,0}), which may not be directly available as metadata. In this case, the amount of absorption may be estimated from available parameters, specifically the reverberation energy ratio or the combination of reverberation time RT60 and volume of Space 2. Patent application publication No. WO/2023/031182 describes methods for deriving the amount of absorption from these other parameters.

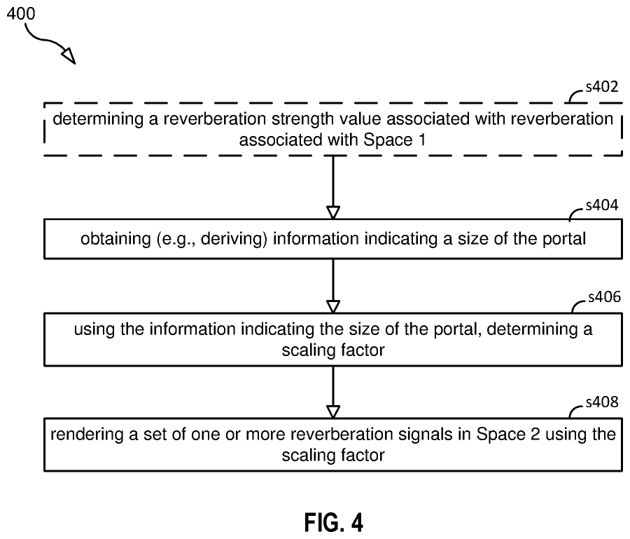

FIG. 4 is a flowchart illustrating a process 400 according to some embodiments for rendering reverberation in a second space, Space 2, connected to a first space, Space 1, via a portal. Process 400 may be performed by audio renderer 151. Process 400 may begin with optional step s402.

Optional step s402 comprises determining a reverberation strength value associated with reverberation associated with Space 1.

Step s404 comprises obtaining (e.g., deriving) information indicating a size of the portal.

Step s406 comprises using the information indicating the size of the portal, determining a scaling factor.

Step s408 comprises rendering a set of one or more Space 2 reverberation signals in Space 2 using the scaling factor and, optionally, the reverberation strength value.

In some embodiments, the method further comprises obtaining a reverberation strength value associated with reverberation associated with the first space (step s402), and the step of rendering the first set of one or more reverberation signals in the second space using the scaling factor comprises rendering the first set of one or more reverberation signals in the second space using the scaling factor and the reverberation strength value.

In some embodiments, the reverberation strength value is a reverberation level parameter or reverberation energy ratio parameter associated with the first space.

In some embodiments, obtaining the reverberation strength value comprises receiving metadata for the first space, wherein the metadata comprises the reverberation level parameter or reverberation energy ratio parameter associated with the first space.

In some embodiments, a second set of one or more reverberation signals represent reverberation in the first space, and the method further comprises, prior to rendering the first set of reverberation signal(s) in the second space, deriving the first set of one or more reverberation signals from the second set of reverberation signals.

In some embodiments, obtaining the reverberation strength value comprises determining the reverberation strength value based on the second set of one or more reverberation signals.

In some embodiments, deriving the first set of one or more reverberation signals for rendering in the second space comprises down-mixing the second set of one or more reverberation signals.

In some embodiments, the information indicating the size of the portal is a size value, Sₚₒᵣₜₐₗ, and determining the scaling factor comprises calculating C1*Sₚₒᵣₜₐₗ, where C1 is a predetermined value. In some embodiments, C1 is approximately ⅛π. In some embodiments, determining the scaling factor further comprises calculating the square root of C1*Sₚₒᵣₜₐₗ. In some embodiments, determining the scaling factor further comprises determining whether C1*Sₚₒᵣₜₐₗ is less than C2, where C2 is a predetermined number.

In some embodiments, the size value represents a geometrical size of the portal, or the size value represents an acoustic size of the portal.

In some embodiments, the information indicating the size of the portal is a solid angle value, Ωₚₒᵣₜₐₗ, with respect to a position in the second space.

In some embodiments, determining the scaling factor comprises calculating C1*Ωₚₒᵣₜₐₗ, where C1 is a predetermined value.

In some embodiments, determining the scaling factor further comprises calculating the square root of C1*Ωₚₒᵣₜₐₗ.

In some embodiments, C1 is 1/(4π).

In some embodiments, rendering the first set of one or more reverberation signals in the second space comprises rendering the first set of one or more reverberation signals as an extended sound source.

In some embodiments, a second set of one or more reverberation signals represent reverberation in the first space, and rendering the first set of reverberation signal(s) in the second space comprises: deriving one or more reverberation input signals from the second set of reverberation signals; and generating the first set of one or more reverberation signals using the one or more reverberation input signals.

In some embodiments, generating the first set of one or more reverberation signals using the one or more reverberation input signals comprises generating the first set of one or more reverberation signals using the one or more reverberation input signals and the scaling factor.

In some embodiments, the method further comprises rendering the one or more reverberation input signals in the second space using a second scaling factor determined using the information indicating the size of the portal.

In some embodiments, deriving the one or more reverberation input signals comprises down-mixing the second set of one or more reverberation signals.

In some embodiments, the method further comprises, prior to deriving the one or more reverberation input signals, generating the second set of one or more reverberation signals using reverberation control information associated with the first space.

In some embodiments, the reverberation control information associated with the first space comprises a reverberation level parameter or reverberation energy ratio parameter associated with the first space.

In some embodiments, the information indicating the size of the portal is a size value, Sₚₒᵣₜₐₗ, and the scaling factor is equal to Sₚₒᵣₜₐₗ/(16π).

In some embodiments, generating the first set of one or more reverberation signals comprises generating the first set of one or more reverberation signals in accordance with reverberation characteristics corresponding to the second space.

In some embodiments, generating the first set of one or more reverberation signals in accordance with reverberation characteristics corresponding to the second space comprises generating the first set of one or more reverberation signals using reverberation control information associated with the second space.

In some embodiments, the reverberation control information associated with the second space comprises a reverberation level parameter or reverberation energy ratio parameter associated with the second space.

In some embodiments, rendering the first set of one or more reverberation signals in the second space comprises rendering the first set of one or more reverberation signals as an immersive sound field.

In some embodiments, the method further comprises, prior to deriving the first set of one or more reverberation signals, generating the second set of one or more reverberation signals using reverberation control information associated with the first space.

In some embodiments, the reverberation control information associated with the first space comprises a reverberation level parameter or reverberation energy ratio parameter associated with the first space.

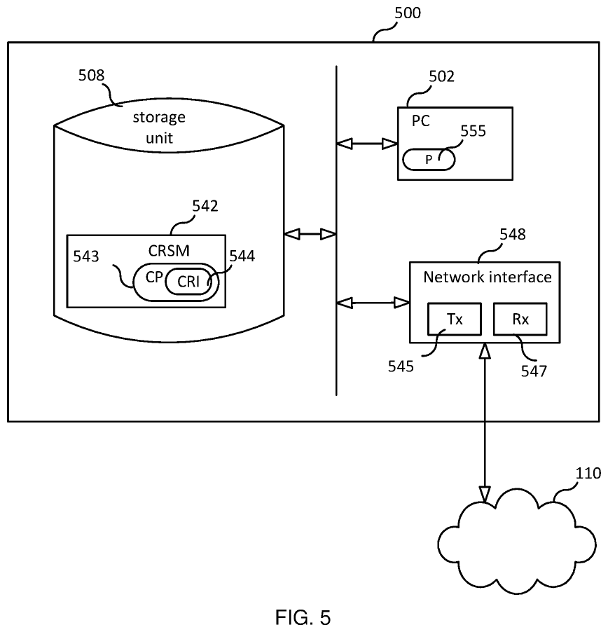

FIG. 5 is a block diagram of an audio rendering apparatus 500, according to some embodiments, for performing the methods disclosed herein (e.g., audio renderer 151 may be implemented using audio rendering apparatus 500). As shown in FIG. 5, audio rendering apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 500 may be a distributed computing apparatus); at least one network interface 548 comprising a transmitter (Tx) 545 and a receiver (Rx) 547 for enabling apparatus 500 to transmit data to and receive data from other nodes connected to a network 110 (e.g., an Internet Protocol (IP) network) to which network interface 548 is connected (directly or indirectly) (e.g., network interface 548 may be wirelessly connected to the network 110, in which case network interface 548 is connected to an antenna arrangement); and a storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes audio rendering apparatus 500 to perform steps described herein (e.g., steps described herein with reference to the flow charts). In other embodiments, audio rendering apparatus 500 may be configured to perform steps described herein without the need for code. That is, for example, PC 502 may consist merely of one or more ASICs. Hence, the features of the embodiments described herein may be implemented in hardware and/or software.

### Summary of Additional Various Embodiments

A1. A method performed by an audio renderer for rendering reverberation in a second space, Space 2, connected to a first space, Space 1, via a portal, the method comprising: determining a reverberation strength value associated with reverberation associated with Space 1; obtaining (e.g., deriving) information indicating a size of the portal; using the information indicating the size of the portal, determining a scaling factor; and rendering a set of one or more Space 2 reverberation signals in Space 2 using the scaling factor and the reverberation strength value.
A2. The method of embodiment A1, wherein a set of one or more reverberation signals represent a reverberation sound field in Space 1 (this set of one or more signals is referred to as “Space 1 reverberation signals”), and the method further comprises, prior to rendering the Space 2 reverberation signal(s), deriving, the set of one or more Space 2 reverberation signals from the Space 1 reverberation signals.
A3. The method of embodiment A2, wherein determining the reverberation strength value comprises determining the reverberation strength value based on the set of one or more Space 1 reverberation signals.
A4. The method of embodiment A2 or A3, wherein deriving the set of one or more Space 2 reverberation signals for rendering in Space 2 comprises down-mixing the set of one or more Space 1 reverberation signals.
A5. The method of any one of embodiments, A1-A4, wherein the information indicating the size of the portal is a size value, Sₚₒᵣₜₐₗ, and determining the scaling factor comprises calculating C1*Sₚₒᵣₜₐₗ, where C1 is a predetermined value.
A6. The method of embodiment A5, wherein C1 is approximately ⅛π.
A7. The method of embodiment A5 or A6, wherein determining the scaling factor further comprises calculating the square root of C1*Sₚₒᵣₜₐₗ.
A8. The method of embodiment A5 or A6, wherein determining the scaling factor further comprises determining whether C1*Sₚₒᵣₜₐₗ is less than C2, where C2 is a predetermined number (e.g., 0.5).
A9. The method of any one of embodiments, A1-A4, wherein the information indicating the size of the portal is a solid angle value, Ωₚₒᵣₜₐₗ.
A10. The method of embodiment A9, wherein determining the scaling factor comprises calculating C1*Ωₚₒᵣₜₐₗ, where C1 is a predetermined value (e.g., C1=¼π).
A11. The method of embodiment A10, wherein determining the scaling factor further comprises calculating the square root of C1*Ωₚₒᵣₜₐₗ.
B1. A computer program comprising instructions which when executed by processing circuitry of an audio renderer causes the audio renderer to perform the method of any one of the above embodiments.
B2. A carrier containing the computer program of embodiment B1, wherein the carrier is one of an electronic signal, an optical signal, a radio signal, and a computer readable storage medium.
C1. An audio rendering apparatus that is configured to perform the method of any one of the above embodiments.
C2. The audio rendering apparatus of embodiment C1, wherein the audio rendering apparatus comprises memory and processing circuitry coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by an audio renderer for rendering reverberation in a second space connected to a first space via a portal, the method comprising:
obtaining information indicating a size of the portal;
using the information indicating the size of the portal, determining a scaling factor; and
rendering a first set of one or more reverberation signals in the second space using the scaling factor.

2. The method of claim 1, wherein
the method further comprises obtaining a reverberation strength value associated with reverberation associated with the first space, and
the step of rendering the first set of one or more reverberation signals in the second space using the scaling factor comprises rendering the first set of one or more reverberation signals in the second space using the scaling factor and the reverberation strength value.

3. The method of claim 2, wherein the reverberation strength value is a reverberation level parameter or reverberation energy ratio parameter associated with the first space.

4. The method of claim 3, wherein obtaining the reverberation strength value comprises receiving metadata for the first space, wherein the metadata comprises the reverberation level parameter or reverberation energy ratio parameter associated with the first space.

5. The method of claim 1, wherein
a second set of one or more reverberation signals represent reverberation in the first space, and
the method further comprises, prior to rendering the first set of reverberation signal(s) in the second space, deriving the first set of one or more reverberation signals from the second set of reverberation signals.

6. (canceled)

7. The method of claim 5, wherein deriving the first set of one or more reverberation signals for rendering in the second space comprises down-mixing the second set of one or more reverberation signals.

8. The method of claim 1, wherein
the information indicating the size of the portal is a size value, Sₚₒᵣₜₐₗ, and
determining the scaling factor comprises calculating C1*Sₚₒᵣₜₐₗ, where C1 is a predetermined value.

9-11. (canceled)

12. The method of claim 8, wherein
the size value represents a geometrical size of the portal, or
the size value represents an acoustic size of the portal.

13. The method of claim 1, wherein
the information indicating the size of the portal is a solid angle value, Ωₚₒᵣₜₐₗ, with respect to a position in the second space.

14-16. (canceled)

17. The method of claim 1, wherein rendering the first set of one or more reverberation signals in the second space comprises rendering the first set of one or more reverberation signals as an extended sound source.

18. The method of claim 1, wherein
a second set of one or more reverberation signals represent reverberation in the first space, and
rendering the first set of reverberation signal(s) in the second space comprises:
deriving one or more reverberation input signals from the second set of reverberation signals; and
generating the first set of one or more reverberation signals using the one or more reverberation input signals.

19. The method of claim 18, wherein generating the first set of one or more reverberation signals using the one or more reverberation input signals comprises generating the first set of one or more reverberation signals using the one or more reverberation input signals and the scaling factor.

20. The method of claim 19, wherein the method further comprises rendering the one or more reverberation input signals in the second space using a second scaling factor determined using the information indicating the size of the portal.

21. The method of claim 18, wherein deriving the one or more reverberation input signals comprises down-mixing the second set of one or more reverberation signals.

22. The method of claim 18, wherein the method further comprises, prior to deriving the one or more reverberation input signals, generating the second set of one or more reverberation signals using reverberation control information associated with the first space.

23. The method of claim 22, wherein the reverberation control information associated with the first space comprises a reverberation level parameter or reverberation energy ratio parameter associated with the first space.

24. The method of claim 18, wherein
the information indicating the size of the portal is a size value, Sₚₒᵣₜₐₗ, and
the scaling factor is equal to Sₚₒᵣₜₐₗ/(16π).

25. The method of claim 18, wherein
generating the first set of one or more reverberation signals comprises generating the first set of one or more reverberation signals in accordance with reverberation characteristics corresponding to the second space.

26. The method of claim 25, wherein
generating the first set of one or more reverberation signals in accordance with reverberation characteristics corresponding to the second space comprises generating the first set of one or more reverberation signals using reverberation control information associated with the second space.

27. The method of claim 26, wherein
the reverberation control information associated with the second space comprises a reverberation level parameter or reverberation energy ratio parameter associated with the second space.

28. The method of claim 18, wherein
rendering the first set of one or more reverberation signals in the second space comprises rendering the first set of one or more reverberation signals as an immersive sound field.

29. The method of claim 5, wherein
the method further comprises, prior to deriving the first set of one or more reverberation signals, generating the second set of one or more reverberation signals using reverberation control information associated with the first space.

30. The method of claim 29, wherein the reverberation control information associated with the first space comprises a reverberation level parameter or reverberation energy ratio parameter associated with the first space.

31. An audio rendering apparatus that is configured to perform a method for rendering reverberation in a second space connected to a first space via a portal, the method comprising:
obtaining information indicating a size of the portal;
using the information indicating the size of the portal, determining a scaling factor; and
rendering a first set of one or more reverberation signals in the second space using the scaling factor.

32. The audio rendering apparatus of claim 31, wherein
the method further comprises obtaining a reverberation strength value associated with reverberation associated with the first space, and
the step of rendering the first set of one or more reverberation signals in the second space using the scaling factor comprises rendering the first set of one or more reverberation signals in the second space using the scaling factor and the reverberation strength value.

33-34. (canceled)
